(19) United States
(12) Patent Application Publication
(10) Pub. No.: US 2009/0174564 A1
(43) Pub. Date: Jul. 9, 2009

(54) DUST DETECTING CIRCUIT

(75) Inventor: Han-Qiao Hu, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/048,227

(22) Filed: Mar. 14, 2008

(30) Foreign Application Priority Data
Jan. 9, 2008 (CN) 200810300051.0

(51) Int. Cl. G08B 21/00; G10K 9/00

(52) U.S. Cl. 340/661; 340/388.1

(57) ABSTRACT

A dust detecting circuit includes a sampling circuit and an alarm circuit. The sampling circuit has a first voltage amplifying circuit, a voltage comparing circuit, and a second voltage amplifying circuit. An input of the first voltage amplifying circuit is connected to an output of a dust sensor; two inputs of the voltage comparing circuit are respectively connected to a power supply for receiving a reference voltage and an output of the first voltage amplifying circuit. An output of the voltage comparing circuit is connected to an input of the second voltage amplifying circuit. An alarm circuit is connected to an output of the second voltage amplifying circuit. When the amount of the dust is more than a pre-determined threshold, a high level voltage signal is output from the sampling circuit to the alarm circuit, and the alarm circuit activates an alarm.

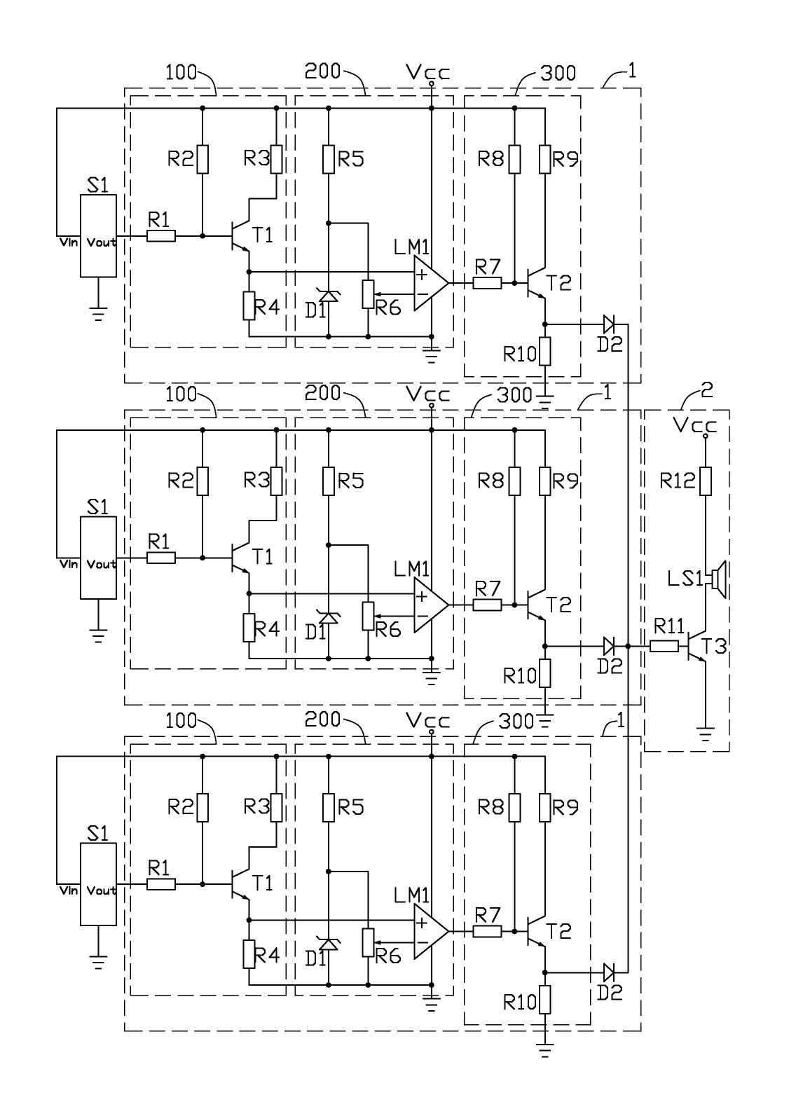

### BACKGROUND

1. Field of the Invention

The present invention relates to detecting circuits, and particularly to a dust detecting circuit which can detect when there is too much dust in a computer.

2. Description of Related Art

Computers are easily invaded by dust. When there is too much dust collected in a computer, cooling becomes inefficient and components may overheat.

What is needed is to provide a dust detecting circuit which can detect when there is too much dust in a computer.

### SUMMARY

A dust detecting circuit includes a sampling circuit and an alarm circuit. The sampling circuit has a first voltage amplifying circuit, a voltage comparing circuit, and a second voltage amplifying circuit. An input of the first voltage amplifying circuit is connected to an output of a dust sensor; two inputs of the voltage comparing circuit are respectively connected to a power supply for receiving a reference voltage and an output of the first voltage amplifying circuit. An output of the voltage comparing circuit is connected to an input of the second voltage amplifying circuit. An alarm circuit is connected to an output of the second voltage amplifying circuit. When the amount of the dust is more than a pre-determined threshold, a high level voltage signal is output from the sampling circuit to the alarm circuit, and the alarm circuit activates an alarm.

Other advantages and novel features of the present invention will become more apparent from the following detailed description of an embodiment when taken in conjunction with the accompanying drawing, in which:

### BRIEF DESCRIPTION OF THE DRAWING

The drawing is a circuit diagram of a dust detecting circuit in accordance with an embodiment of the present invention.

### DETAILED DESCRIPTION

Referring to the drawing, a dust detecting circuit in accordance with an embodiment of the present invention includes three identical sampling circuits 1, and an alarm circuit 2. In this embodiment, the three identical sampling circuits 1 are configured to detect whether there is too much dust around the CPU, the memory bank, and the CD-ROM respectively. In other embodiments, the state of the dust at other locations can be detected by increasing the number of or relocating the sampling circuits 1.

Each sampling circuit 1 includes a diode D2, a first voltage amplifying circuit 100 having four resistors R1˜R4 and an NPN transistor T1, a voltage comparing circuit 200 having a resistor R5, a variable resistor R6, a zener diode D1 and a comparator LM1, and a second voltage amplifying circuit 300 having four resistors R7˜R10 and an NPN transistor T2. In the first voltage amplifying circuit 100, one end of the resistor R1 is connected to an output Vout of a dust sensor S1 and the other end of the resistor R1 is connected to the base of the NPN transistor T1, an input Vin of the dust sensor S1 is connected to a power supply Vcc, one end of the resistor R2 is connected to the base of the NPN transistor T1 and the other end of the resistor R2 is connected to the power supply Vcc, the collector of the NPN transistor T1 is connected to the power supply Vcc via the resistor R3, the emitter of the NPN transistor T1 is grounded via the resistor R4. In the voltage comparing circuit 200, one end of the resistor R5 is connected to the power supply Vcc and the other end of the resistor R5 is connected to the cathode of the zener diode D1, the anode of the zener diode D1 is grounded, one fixed end of the variable resistor R6 is connected to the cathode of the zener diode D1 and the other fixed end of the variable resistor R6 is grounded, a sliding end of the variable resistor R6 is connected to an inverting terminal of the comparator LM1, and a non-inverting terminal of the comparator LM1 is connected to the emitter of the NPN transistor T1. In the second voltage amplifying circuit 300, one end of the resistor R7 is connected to the output of the comparator LM1, and the other end of the resistor R7 is connected to the base of the NPN transistor T2, the base of the NPN transistor T2 is also connected to the power supply Vcc via the resistor R8, the collector of the NPN transistor T2 is connected to the power supply Vcc via the resistor R9 and the emitter of the NPN transistor T2 is grounded via the resistor R10, the anode of the diode D2 is connected to the emitter of the NPN transistor T2, and the cathode of the diode D2 acting as the output of each sampling circuit 1 is connected to the alarm circuit 2.

The alarm circuit 2 includes two resistors R11 and R12, an NPN transistor T3, and a buzzer LS1. One end of the resistor R11 is connected to each output of the sampling circuits 1, the other end of the resistor R11 is connected to the base of the NPN transistor T3, the collector of the NPN transistor T3 is connected to the power supply Vcc via the buzzer LS1 and the resistor R12, and the emitter of the NPN transistor T3 is grounded.

In use, the sensor S1 detects whether there is too much dust at its location. For example, in this embodiment, when the amount of dust present is less than a pre-determined threshold, a voltage signal generated by the sensor S1 will be low level (voltage below a threshold). If there is too much dust at the location then the sensor S1 generates a high level voltage signal (voltage upon a threshold).

The first voltage amplifying circuit 100 amplifies the voltage signal and sends it to the voltage comparing circuit 200. The voltage comparing circuit 200 compares the voltage signal with a reference voltage at the inverting terminal of the comparator LM1. If the voltage at the non-inverting terminal of the comparator LM1 is lower than the reference voltage at the inverting terminal of the comparator LM1, the dust is less than the pre-determined threshold at the location, and a low level voltage (zero volts) signal is output from the sampling circuit 1 to the alarm circuit 2. When the alarm circuit receives the low level voltage signal, the NPN transistor T3 is off and the buzzer LS1 is not activated.

If the voltage at the non-inverting terminal of the comparator LM1 is higher than the reference voltage, then too much dust at the location is indicated, and a high level voltage signal is sent to the alarm circuit 2, which biases the base of the NPN transistor T3, turning the transistor NPN T3 on, and the buzzer LS1 activates an alarm.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A dust detecting circuit comprising:
a sampling circuit having a first voltage amplifying circuit, a voltage comparing circuit and a second voltage amplifying circuit, an input of the first voltage amplifying circuit connected to an output of a dust sensor, two inputs of the voltage comparing circuit respectively connected to an output of the first voltage amplifying circuit and a power supply for receiving a reference voltage, an output of the voltage comparing circuit connected to an input of the second voltage amplifying circuit; and
an alarm circuit connected to an output of the second voltage amplifying circuit, when the amount of the dust is more than a pre-determined threshold, a high level voltage signal is output from the sampling circuit to the alarm circuit, and the alarm circuit activates an alarm.

2. The dust detecting circuit as claimed in claim 1, wherein the first voltage amplifying circuit comprises a first resistor, a second resistor, a third resistor, a fourth resistor and a first NPN transistor, one end of the first resistor is connected to the output of the dust sensor and the other end of the first resistor is connected to the base of the first NPN transistor, one end of the second resistor is connected to the base of the first NPN transistor and the other end of the second resistor is connected to the power supply, the collector of the first NPN transistor is connected to the power supply via the third resistor, and the emitter of the first NPN transistor is grounded via the fourth resistor.

3. The dust detecting circuit as claimed in claim 1, wherein the voltage comparing circuit comprises a fifth resistor, a variable resistor, a zener diode, and a comparator, one end of the fifth resistor is connected to the power supply and the other end is connected to the cathode of the zener diode, the anode of the zener diode is grounded, one fixed end of the variable resistor is connected to the cathode of the zener diode and the other fixed end is grounded, a sliding end of the variable resistor is connected to an inverting terminal of the comparator, and a non-inverting terminal of the comparator is connected to the emitter of the first NPN transistor.

4. The dust detecting circuit as claimed in claim 1, wherein the second voltage amplifying circuit comprises a seventh resistor, an eighth resistor, a ninth resistor, a tenth resistor and a second NPN transistor, one end of the seventh resistor is connected to an output of the comparator, and the other end is connected to the base of the second NPN transistor, the base of the second NPN transistor is also connected to the power supply via the eighth resistor, the collector of the second NPN transistor is connected to the power supply via the ninth resistor and the emitter of the second NPN transistor is grounded via the tenth resistor.

5. The dust detecting circuit as claimed in claim 1, wherein the sampling circuit further comprises a diode, the anode of the diode is connected to the emitter of the corresponding second NPN transistor, and the cathode of the diode is connected to the alarm circuit.

6. The dust detecting circuit as claimed in claim 1, wherein the alarm circuit comprises an eleventh resistor, a twelfth resistor, a third NPN transistor and a buzzer, one end of the eleventh resistor is connected to the output of the sampling circuit, the other end is connected to the base of the third NPN transistor, the collector of the third NPN transistor is connected to the power supply via the buzzer and the twelfth resistor, and the emitter of the third NPN transistor is grounded.

7. The dust detecting circuit as claimed in claim 1, wherein the number of the sampling circuit can be increased.
